(19) United States
(12) Patent Application Publication
(10) Pub. No.: US 2025/0047004 A1
(43) Pub. Date: Feb. 6, 2025

(54) HELICAL ANTENNAE, ALONG WITH THEIR METHODS OF USE AND PRODUCTION

(71) Applicant: The Trustees of the California State University, Long Beach, CA (US)

(72) Inventor: Reza Kamali-Sarvestani, San Diego, CA (US)

(73) Assignee: The Trustees of the California State University, Long Beach, CA (US)

(21) Appl. No.: 18/791,182

(22) Filed: Jul. 31, 2024

Related U.S. Application Data
(60) Provisional application No. 63/529,841, filed on Jul. 31, 2023.

(51) Int. Cl. H01Q 11/08; H04B 17/00

(52) U.S. Cl. CPC H01Q 11/083; H04B 17/0087

(57) ABSTRACT

Embodiments disclosed herein show a novel helical meandered antenna, wherein some embodiments feature tunability through the application of DC voltage to switch and connect multiple antenna arms. The design, successfully fabricated and tested for wireless applications, exhibits a compact size and omnidirectional radiation pattern. The use of diodes as effective components for tunability is explored, allowing adjustments in the operating frequency of the helix. Extensive simulations and measurements were conducted on over 15 different antenna designs, showing consistent results. The proposed helical antenna demonstrates a fine-tunable operation frequency change from 459 MHz to 338 MHz (over 30% change) with low voltage supplied DC from 0 V to 1.5 V.

This United States Utility Patent application claims priority to U.S. Provisional Patent Application Ser. No. 63/529,841, which is entitled “Tunable Helical Antennae, Along With Their Methods of Use and Production”, was filed on Jul. 31, 2023, and is commonly owned and incorporated herein in its entirety by reference.

### FIELD OF THE SUBJECT MATTER

The field of the subject matter is helical antennae, their methods of use and their methods of production.

### BACKGROUND

As the demand for smaller, more efficient antennas continues to grow, helical antennas fabricated through printed circuit boards (PCB) offer a promising solution that could shape the future of wireless communication technology. With ongoing developments and refinements, PCB-based helical antennas may soon become a ubiquitous feature in our interconnected world, enabling easier integration, and more reliable wireless communication in various frequency ranges [1], [2]. They can achieve the desired electrical length within a smaller physical structure compared to other antenna types [3]. This makes them suitable for applications where space is limited or where larger antennas are impractical such as High Frequency (HF) applications. In addition, helical antennas have a wide bandwidth, meaning they can operate over a broad range of frequencies. This versatility makes them useful in applications that require coverage across multiple frequency bands. As disclosed herein, a tunable helical antenna is made with line meandering and embedded in a printed circuit board. This new antenna has a low profile, wideband range, and easy fabrication process for a helical antenna.

The helical meandering line configuration of the antenna was first reported by Kraus with several advantages in terms of its electrical length, radiation pattern, and impedance matching [4]. This unique antenna design was then tailored for the bandwidth of 3 MHz to 30 MHz, catering to the requirements of high-frequency surface wave radar (HFSWR) systems [5]. One of the key benefits of the helical meandering line configuration is its ability to provide an increased electrical length within a compact physical size. This extended electrical length enables the antenna to efficiently radiate and receive electromagnetic waves in the desired frequency range, thereby achieving the necessary performance for long-range communications [5].

By leveraging the advantages of PCB technology, the helical antenna was produced using a layer-by-layer fabrication process. This approach involved etching the necessary antenna structure directly onto the PCB substrate, resulting in a more streamlined and precise manufacturing process. Another advantage is the cost-effectiveness of PCB-based helical antennas. PCB fabrication techniques are well-established and widely adopted in the electronics industry, making the mass production of these antennas more affordable and accessible compared to traditional methods. This could lead to significant cost savings in antenna manufacturing and deployment.

The development of tunable antennas holds significant importance in the current wireless technology landscape with limited frequency spectrum available. With the ever-increasing demand for higher data rates, improved connectivity, and efficient spectrum utilization, tunable antennas offer a flexible solution that can adapt to changing communication requirements. These antennas have the potential to revolutionize wireless communication by providing greater versatility, adaptability, and reliability in a rapidly evolving and congested radio frequency environment.

The goal of the contemplated design and embodiments presented herein is to show that a new antenna was made using multiple helical antennas, arms, through PCB, with tunability using DC voltage applied to switch and connect these antenna arms in the multiple-arm structure. Contemplated designs were successfully fabricated, tested, and used for wireless application. This type of antenna is commonly used for various wireless communication applications because of its compact size, wide bandwidth, and omnidirectional radiation pattern.

### SUMMARY OF THE SUBJECT MATTER

Tunable helical antennae disclosed herein comprise at least one arm, wherein each arm has at least one turn, and a substrate having a width, a length, a thickness, an upper surface and a lower surface, wherein the at least one arm is located on the upper surface, on the lower surface, or on both the upper surface and the lower surface. In some embodiments, a contemplated tunable helical antenna is a meandered antenna. In other embodiments, a contemplated tunable helical antenna is rendered tunable by exerting control over at least one parameter, and wherein the at least one parameter includes inductance, capacitance, connectivity of the antenna, and structure design.

In another contemplated embodiment, tunable helical antennae disclosed herein comprise at least one arm, wherein each arm has at least one turn, and a substrate having a width, a length, a thickness, an upper surface and a lower surface, wherein the at least one arm is located in at least part of the upper surface, in at least part of the lower surface, or in at least part of both the upper surface and the lower surface.

A method of making a tunable helical antenna includes providing a substrate, providing an antenna material, and etching an antenna structure onto the substrate, into the substrate, or a combination thereof. Contemplated methods may further comprise rendering the antenna tunable by exerting control over at least one parameter, and wherein the at least one parameter includes inductance, capacitance, connectivity of the antenna, and structure design.

### BRIEF DESCRIPTION OF THE FIGURES

FIG. 1 shows the structure of a three-arm helical meandered antenna.

FIG. 2 shows the circuit configuration for the tunable three arms helical meandered antenna.

FIG. 3 shows pictures of a four arms helical meandered tunable antenna fabricated through PCB using FR4: a) top layer; b) bottom layer.

FIG. 4 shows the return loss of a three arms helical meandered antenna fabricated through PCB over a measured from 300 kHz to 5 GHz and simulated from 0 to 5 GHz.

FIG. 5 shows simulated and measured radiation patterns for a three-arms helical meandered antenna fabricated through PCB, at 300 MHZ, in XoY-plane: a) Co-pol; b) X-pol.

FIG. 6 shows a comparison of measured return loss and frequency of operation for three arms tunable meandered helix tuned with 16 different DC voltages from 0V to 1.5 V.

### DETAILED DESCRIPTION

The design of a multi-arm helical meandered antenna fabricated through PCB involved creating a compact and efficient antenna structure using printed circuit board (PCB) technology. In these contemplated designs, the target frequencies were below 500 MHz and FR4 (a composite material composed of woven fiberglass cloth with an epoxy resin binder that is flame resistant) was efficient enough to be chosen for lowering the costs. Contemplated embodiments can significantly minimize the size of antennas. Compared to current antennas, contemplated embodiments are smaller for large wavelength radio wave propagation, and they can easily get integrated into the circuits. In addition, contemplated embodiments include tunable helical meandered antennae. Contemplated embodiments have a very wide range of tunability compared to other tunable antennas. It is possible to fine-tune contemplated antennae without any extra filtering. As used herein, a “meandered antenna” is one that is designed by bending the conventional linear monopole antenna to decrease the size of antenna. The influence of the meander part of the antenna is similar to a load and the meander line sections are considered as shorted-terminated transmission lines.

Tunable helical antennae disclosed herein comprise: at least one arm, wherein each arm has at least one turn, and a substrate having a width, a length, a thickness, an upper surface and a lower surface, wherein the at least one arm is located on the upper surface, on the lower surface, or on both the upper surface and the lower surface. In some embodiments, a contemplated tunable helical antenna is a meandered antenna. In other embodiments, a contemplated tunable helical antenna is rendered tunable by exerting control over at least one parameter, and wherein the at least one parameter includes inductance, capacitance, connectivity of the antenna, and structure design.

In another contemplated embodiment, tunable helical antennae disclosed herein comprise: at least one arm, wherein each arm has at least one turn, and a substrate having a width, a length, a thickness, an upper surface and a lower surface, wherein the at least one arm is located in at least part of the upper surface, in at least part of the lower surface, or in at least part of both the upper surface and the lower surface.

A method of making a tunable helical antenna includes: providing a substrate, providing an antenna material, and etching an antenna structure onto the substrate, into the substrate, or a combination thereof. Contemplated methods may further comprise rendering the antenna tunable by exerting control over at least one parameter, and wherein the at least one parameter includes inductance, capacitance, connectivity of the antenna, and structure design.

Contemplated embodiments demonstrate novel advancements in the fabrication and operation of helical structure antennas, addressing their applicability across radio frequency ranges from low frequency (LF) to extra high frequency (EHF). Notably, these advancements yield the significant advantage of reducing antenna size while enhancing their tunability. By adopting this innovative method, conventional helical meandered antennas can be rendered tunable by exerting control over one or more of the following parameters: 1) inductance, 2) capacitance, 3) connectivity of the antenna structure using various types of switches, such as diodes, transistors, electromechanical, or mechanical, and 4) reconfiguring the structure. It means the helical meandered antenna will become tunable and operation frequency can change in a single antenna very widely. There are some contemplated embodiments wherein the antennae may not be tunable, but instead may be a fixed frequency.

These groundbreaking embodiments encompass the fabrication of helical meandered antennas using helical planar antennas constructed through printed circuit boards (PCBs) or substrates incorporating vias. This enables the creation of versatile structures with varying numbers of arms (solenoids), pitch size, number of turns, width, length, or board thickness, thereby achieving the desired target operation frequency for specific applications. In addition, while some contemplated helical antennae may be constructed on a single printed circuit board, there are other contemplated embodiments that may be constructed on multiple printed circuit boards or substrates to cover isotropic propagation.

The newly developed helical meandered tunable antenna exhibits exceptional capabilities, allowing for seamless tuning, filtering, and selective operation across an extensive range of frequencies contingent upon the antenna's specific structure. Furthermore, the planar helical meandered antenna is uniquely designed to function selectively at its lower operating frequency and operate as a wideband antenna at higher operating frequencies. This dual functionality offers enhanced versatility, making it an ideal choice for diverse communication requirements.

Moreover, this innovative fabrication and operational approach not only simplifies the tuning process but also enhances the overall performance and adaptability of helical meandered antennas, leading to improved communication systems in various industries and applications.

Tunability of any helical meandered antenna can be done using circuits or methods that are using at least one of the following parameters: changing of inductance, changing of capacitance, switching to connect or disconnect the antenna elements that can be done by electromechanical or semiconductor switching; and changing formation of antenna elements.

For example, a three-arm helical meandered antenna consisting of three helical arms that were interconnected forms a continuous meandering pattern. The helical structure was formed by carefully arranging the conductive traces on the PCB substrate. Each helical arm was responsible for radiating or receiving electromagnetic waves independent of other arms. The meandering pattern of the helical arms allows for increased electrical path length within a limited physical space. FIG. 1 illustrates the structure of the three-arm helical meandered antenna. In this contemplated embodiment 100, three arms 110 are etched into a board or substrate 120. The analytical model of each solenoid embedded solenoid in PCB was investigated by considering the thickness of copper clad as “b”. The other parameters of the structure are displayed in FIG. 1. The main parameters are the width of each antenna arm a, the width of conductors w, the pitch size d, and the thickness of the board h.

Using the elements of this structure the inductance and capacitance of the turn-by-turn helical design in each arm can be calculated. This calculation was used to estimate the resonance frequency of the antenna.

### Inductances

The self-inductance of a cylindrical via inside the substrate is named L_{cs} with the approximate value of [6]:

$${L}_{cs} = 2 l [ ln ( \frac{h}{w} ) - 0.75 + \frac{w}{2 h} ] \qquad ( 1 )$$

Where h is the height and w is the diameter of the via in centimeters. The value of w is also equal to the width of the surface conductors. FIG. 1 illustrates the dimension and size of a one-turn resonator. If b would be considered as the thickness of copper and w as the width of the segment in centimeters, then the self-inductance of a rectangular wire of length α is Lᵣₛ could be evaluated by [6]:

$${L}_{r s} = 2 a [ ln ( \frac{2 a}{w + b} ) + 0.50049 + ( \frac{w + b}{3 a} ) ] \qquad ( 2 )$$

The mutual inductance of M between each couple of segments can be evaluated by:

$$M = 2 aK \qquad ( 3 )$$

It is positive if the current in both segments followed in the same direction and negative if they are in opposite directions. The parameter of K is given by:

$$K = ln [ ( \frac{a}{D} ) + {( 1 + \frac{{a}^{2}}{{D}^{2}} )}^{\frac{1}{2}} ] - {[ 1 + ( \frac{{D}^{2}}{{a}^{2}} ) ]}^{\frac{1}{2}} + ( \frac{D}{a} ) \qquad ( 4 )$$

Where D could be found using the following equation if d would be the distance between the centers of two conductors.

$$( 5 )$$

$$ln ( D ) ≅ ln ( d ) - [ \text{} \frac{1}{12} {( \frac{d}{w} )}^{2} ] + [ \text{} \frac{1}{60} {( \frac{d}{w} )}^{4} ] + [ \text{} \frac{1}{68} {( \frac{d}{w} )}^{6} ] + [ \frac{1}{360} {( \frac{d}{w} )}^{8} ] + [ \frac{1}{660} {( \frac{d}{w} )}^{10} ]$$

The total inductance of LT is the sum of all self-inductances and mutual inductances for m segments of the coil:

$${L}_{s} = {\sum }_{s = 1}^{m} {L}_{0 \_m} + {\sum }_{s = 1}^{m} {\sum }_{i = 1 , i \neq s}^{m} {M}_{si} \qquad ( 6 )$$

### Capacitances

Based on the position of the segments, capacitances are in the air or inside the FR4 PCB substrate with the relative dielectric constant, εᵣ, of 4. Stray capacitance Cₛ is between segments, parallel capacitances Cp are between segments and ground, and capacitance C_{d} was made using a dielectric layer between two conductors in via. In the calculation of Cₛ for the solenoid, the capacitance between all adjacent segments was considered to offer a close approach for the device value. The stray capacitance is formulated as follows [7]:

$${C}_{s} ≅ {ϵ}_{0} \frac{[ {( {n}_{1} - 1 ) [ {a}^{2} + {( 0.5 d )}^{2} ]}^{\frac{1}{2}} + {n}_{2} a ] b}{( d - w )} + {ϵ}_{r} {ϵ}_{0} \frac{2 {n}_{1} {w [ {a}^{2} + {( 0.5 d )}^{2} ]}^{\frac{1}{2}}}{{[ {h}^{2} + {( 0.5 d )}^{2} ]}^{\frac{1}{2}}} + {ϵ}_{r} {ϵ}_{0} \frac{( 2 {n}_{3} + 1 ) hw}{{[ {a}^{2} + {( 0.5 d )}^{2} ]}^{\frac{1}{2}}} + {ϵ}_{r} {ϵ}_{0} \frac{2 {n}_{3} wh}{( d - w )} \qquad ( 7 )$$

Where n₁ is the number of top layer conductors, n₂ is the number of bottom layer conductors and n₃ is the number of via associated with the resonator in this model.

The lowest resonance frequency can be estimated using the total inductance of Lₛ and Cₛ using:

$$f = \frac{1}{2 π \sqrt{{L}_{s} {C}_{s}}} \qquad ( 8 )$$

The estimated change in the lowest frequency of resonance is calculated using the analytical formula No.8 and illustrated in Table I.

TABLE I
ANALYTICAL ESTIMATION OF FIRST RESONANCE
FREQUENCY OF A 3 ARM ANTENNA FOR
DIFFERENT CONDUCTOR WIDTH (A)

| | Width of the Top Layer Conductor, a (mm) | | | | |
|---|---|---|---|---|---|
| | 5.00 | 7.00 | 8.00 | 9.00 | 10.00 |
| Cₛ(pF) | 1.27 | 1.52 | 1.86 | 2.01 | 2.31 |
| Ls(nH) | 93.10 | 124.90 | 150.75 | 193.10 | 228.90 |
| Resonance | 463.08 | 365.45 | 300.71 | 255.59 | 218.98 |
| f(MHz) | | | | | |

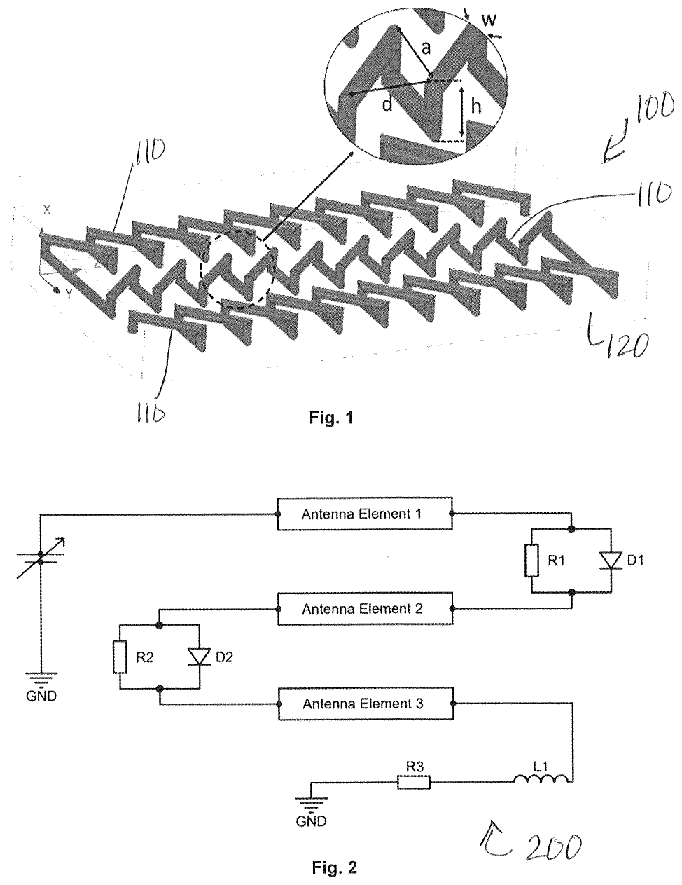

Tunable antennas are important in wireless communication systems because of their ability to adjust their operating frequency, enabling flexible and adaptive performance in various frequency scenarios. Diodes have emerged as a popular and effective component to facilitate tunability in antennas [8]. For example, these diodes exploit the voltage-controlled capacitance variation inherent in their structure or their switching operation of them to change the status of the circuit and result in a change in the resonant frequency of the antenna. Numerous studies have explored the design and implementation of varactor-based tunable antennas. In the novel helical meandered antennae reported here, the diodes were added to control the connection between the inductors. The first arm, the helical antenna, is already connected to the feeder and for every added arm a diode was added in series to control the addition of arms to the antenna structure back-to-back. For example, in a three-arm tunable antenna 200, two diodes parallel to two resistors were added as shown in FIG. 2. Resistors R1 and R2 are making a voltage divider to switch the diode D1 on first and diode D2 after when the DC voltage of variable supply raise from 0 V to 1.5 V. R3 is a current limiter and L1 passes DC while open circuit for radio frequency signals.

The analytical model was used to estimate the size of the antenna by varying the size of the top and bottom copper layers and fixing other parameters. The main parameters are the width of each antenna arm a, the width of conductors w, the pitch size d, and the thickness of the board h. In this design, we used a standard board thickness of 1.5 mm, the width of the conductor w was selected to be 1 mm. The number of turns is fixed at 10 and the length of each arm is 7 cm. The width of helical arms, parameter a of each inductor, is changed to find different resonance frequencies.

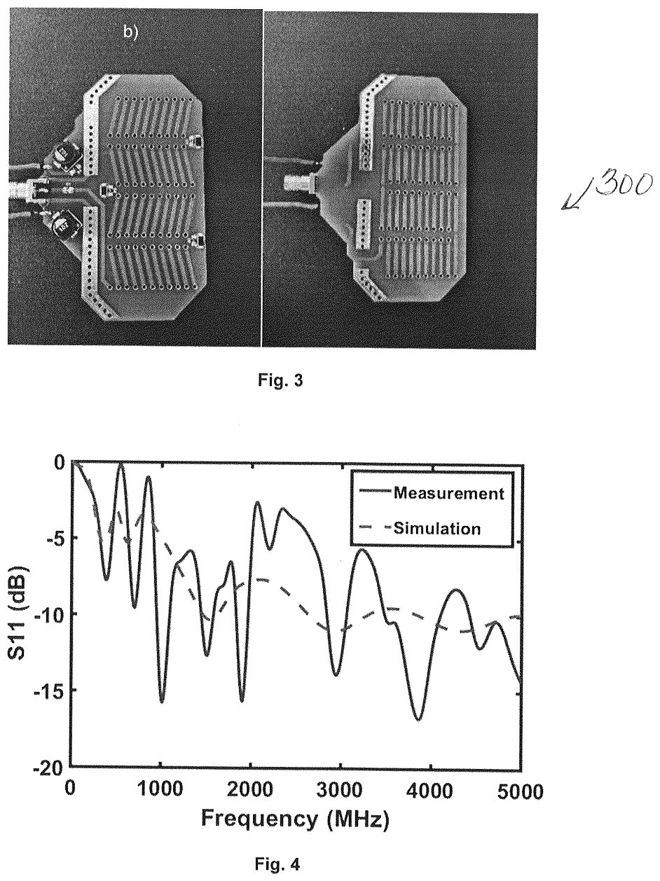

Over 15 different sizes and shapes were designed, simulated, and fabricated with different combinations for the number of arms, turns, pitch size, width, or length. It should be understood that there are multiple additional combinations that can be contemplated, especially given the information provided herein. For the purposes of this example, the board thickness was kept at 1.5 mm in all fabricated samples, but it does not have to be that thickness in all contemplated embodiments. Both directly connected and tunable models were made for these samples and the measurements were consistent with measurements and some small differences were related to error in fabrications. FIG. 3 shows the front and back of a four-arm antenna design 300 through FR4 material.

Consistency between the measured and simulated return losses of 10 turns, 3 arms, a equal to 5 mm, and without tuning circuit antenna is depicted in FIG. 4.

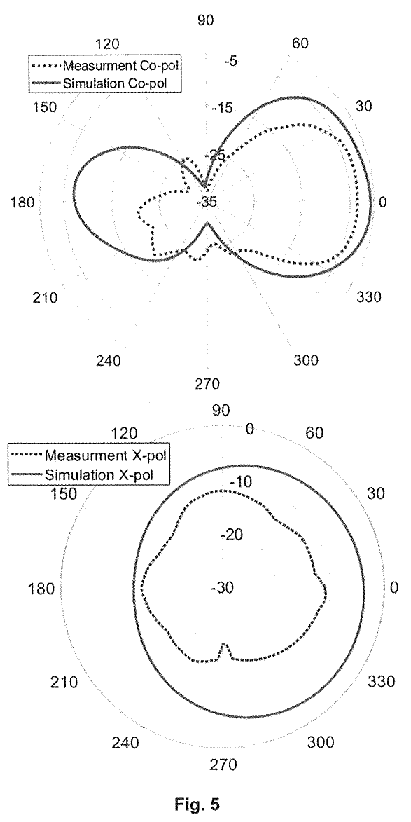

The radiation patterns of the fabricated antenna with three arms at 300 MHZ were simulated and measured. FIG. 5 shows the measured and simulated radiation patterns in the XoY-plane, where Co-pol and X-pol are represented. Simulation was done using Ansys HFSS and measurements were done using antenna measurement set up at the CSUSM laboratory in 5° measurement steps. The Radiation Efficiency was measured using Direct Power Measurement technique and it was 29.4%.

The co-polarization of the antenna exhibited nulls at 0 and 180 degrees, which was expected as the antenna had a solenoid shape structure.

The same antenna was then fabricated with the tunable circuit provided in FIG. 2 and DC voltage from 0 to 1.5 volts was applied to turn on the switching diodes of D1 and then D₂, which are signal diodes 1N4148. We tried different resistor values and a combination of R₁=10 kQ and R₂=33 kQ made a voltage divider with D1 turning gradually on when the voltage increased from 0 V to 1.1 V and D₂ turning fully on right after 1.1 V.

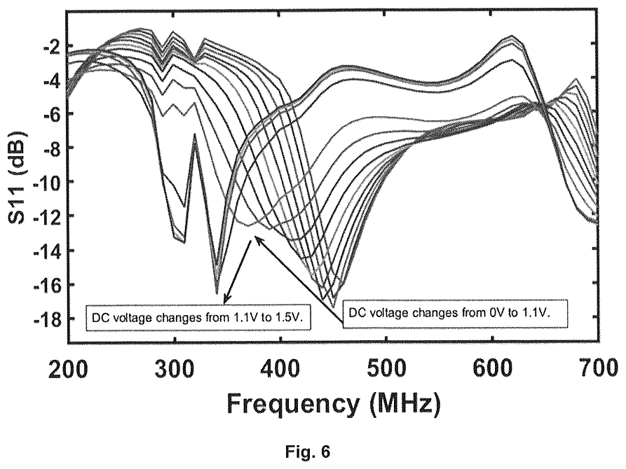

Further increasing voltage after 1.1 V to 1.5 V didn't change the operating frequency because there are not any more element antennas to be added and only reduced the return loss due to lowering of diode resistance. The changes in the measured frequency of operation showed the excitation of D1 was able to activate the second arm and the excitation of D2 activated the third arm. The operating frequency of the antenna under test was tunable by supplied DC voltage and it showed a frequency change from 459 MHz to 338 MHz in this sample. It was an over 30% change in the controlled operation frequency. The measurement of return loss for a tunable helical antenna fabricated using FR4 with different DC voltages is demonstrated in FIG. 6 and it shows the pattern that was previously reported for helical antennas with lower reflection (S11) at higher frequencies [helical antenna]. Impedance bandwidths in DC voltages of 1.1 V to 1.5 V are slightly decreasing due to the change in the internal resistance of the last diode. We tested the three arms antennas in the ISM range of 433-434 MHz and it can immediately be used as a fine tunable antenna for all wireless devices available in that range such as modems, remote controls, etc.

Disclosed herein, as part of the contemplated embodiments, is a novel helical meandered antenna with tunability achieved through diodes to control the connection between its multiple arms. The antenna design was successfully fabricated, tested, and utilized for wireless applications. Its compact size and well-suited for various wireless communication systems. Tunable antennas, like the one proposed herein, play a vital role in wireless communication, offering flexible and adaptive performance across different frequency scenarios. By applying DC voltage through a tunable circuit, the antenna's operating frequency can be adjusted, demonstrating over a 30% change in the controlled operation frequency. The measured performance, consistency between simulations and measurements, and radiation efficiency validation further highlight the effectiveness of the proposed design specially for low frequency application in costal radars and frequency monitoring systems.

### REFERENCES

[1] N. Somjit and J. Oberhammer, “Three-dimensional micromachined silicon-substrate integrated millimeter-wave helical antennas,” IET Microw. Antennas Progag., vol. 7, no. 4, pp. 291-298, January 2013.
[2] A. H. Naqvi, J.-H. Park, C.-W. Baek and S. Lim, “V-Band End-Fire Radiating Planar Micromachined Helical Antenna Using Through-Glass Silicon Via (TGSV) Technology,” in IEEE Access, vol. 7, pp. 87907-87915, 2019.
[3] Z. Chen and Z. Shen, “Planar Helical Antenna of Circular Polarization,” in IEEE Transactions on Antennas and Propagation, vol. 63, no. 10, pp. 4315-4323-10-2015.
[4] J. D. Kraus: Antennas. McGraw-Hill Book Co., Inc., 1950, pp. 214-215.
[5] J. Baker, H.-S. Youn, N. Celik and M. F. Iskander, “Low-Profile Multifrequency HF Antenna Design for Coastal Radar Applications,” in IEEE Antennas and Wireless Propagation Letters, vol. 9, pp. 1119-1122, 2010
[6] F. W. Grover, Inductance Calculations. New York: Van Nostrand, 1946.
[7] R. Kamali-Sarvestani and J. D. Williams, “New high quality factor solenoid based tuned resonator,” 2011 IEEE MTT-S International Microwave Symposium, Baltimore, MD, USA, 2011, pp. 1-1.
[8] Zhu, L., Qian, L., Jiang, W., & Li, L. (2016). Design of Planar Monopole Antennas with Tunable Frequency Characteristics Using Varactor Diodes. International Journal of Antennas and Propagation, 2016, 1-9.

Thus, specific embodiments, methods of tunable helical antennae, their methods of use and their methods of production have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A tunable helical antenna, comprising:
at least one arm, wherein each arm has at least one turn,
a substrate having a width, a length, a thickness, an upper surface and a lower surface, wherein the at least one arm is located on the upper surface, on the lower surface, or on both the upper surface and the lower surface.

2. The tunable helical antenna of claim 1, wherein the antenna is a meandered antenna.

3. The tunable helical antenna of claim 1, wherein the antenna is rendered tunable by exerting control over at least one parameter, and wherein the at least one parameter includes inductance, capacitance, connectivity of the antenna, and structure design.

4. The tunable helical antenna of claim 1, wherein a first arm is already to a feeder each of an additional arm has an added diode in series to control the addition of the additional arms to an antenna structure.

5. The tunable helical antenna of claim 4, wherein the first arm is a helical antenna.

6. A tunable helical antenna, comprising:
at least one arm, wherein each arm has at least one turn,
a substrate having a width, a length, a thickness, an upper surface and a lower surface, wherein the at least one arm is located in at least part of the upper surface, in at least part of the lower surface, or in at least part of both the upper surface and the lower surface.

7. A method of making a tunable helical antenna, comprising:
providing a substrate,
providing an antenna material,
etching an antenna structure onto the substrate, into the substrate, or a combination thereof.

8. The method of claim 7, further comprising rendering the antenna tunable by exerting control over at least one parameter, and wherein the at least one parameter includes inductance, capacitance, connectivity of the antenna, and structure design.
